(19) United States
(12) Patent Application Publication
(10) Pub. No.: US 2020/0231784 A1
(43) Pub. Date: Jul. 23, 2020

(54) REINFORCED THERMOPLASTIC POLYMER COMPOSITIONS INCLUDING LOW DIELECTRIC FLAT GLASS FIBERS AND CORRESPONDING ARTICLES

(71) Applicant: SOLVAY SPECIALTY POLYMERS USA, LLC, Alpharetta, GA (US)

(72) Inventors: Raleigh L. DAVIS, Duluth, GA (US); Keshav S. GAUTAM, Duluth, GA (US)

(21) Appl. No.: 16/634,175

(22) PCT Filed: Aug. 2, 2017
(86) PCT No.: PCT/US2017/045108

§ 371 Date: Jan. 27, 2020

(51) Int. Cl. C08K 7/14; C08G 75/0209; C08G 65/40; C08G 63/183

(52) U.S. Cl. CPC C08K 7/14; C08G 75/0209; C08K 2201/001; C08G 63/183; C08G 65/40

(57) ABSTRACT

Described herein are reinforced thermoplastic polymer compositions including a flat, low-dielectric glass (“D-glass”) fiber. D-glass fiber compositions with a flat morphology provide for polymer compositions having significantly reduced shrinkage and excellent mechanical and dielectric performance. While the flat D-glass fibers can be desirably incorporated into polyester polymers, poly(aryl ether sulfone) polymers, poly(aryl ether ketone) polymers and a polyphenylene sulfide polymers.

This application is a U.S. national stage entry under 35 U.S.C. § 371 of International Application No. PCT/US2017/045108 filed Aug. 2, 2017.

### TECHNICAL FIELD OF THE INVENTION

The invention relates to thermoplastic polymer compositions including a thermoplastic polymer and a flat, low dielectric glass fiber. The invention further relates to articles including the thermoplastic polymer composition.

### BACKGROUND OF THE INVENTION

Mobile electronic devices such as mobile phones, personal digital assistants (PDAs), laptop computers, tablet computers, smart watches, portable audio players, and so on, are in widespread use around the world. Mobile electronic devices are getting smaller and lighter for even more portability and convenience, while at the same time becoming increasingly capable of performing more advanced functions and services, both due to the development of the devices and network systems.

While in the past, low density metals such as magnesium or aluminum, were the materials of choice for mobile electronic parts, synthetic resins have progressively come as at least partial replacement, for costs reasons (some of these less dense metals such as magnesium are somewhat expensive, and manufacturing the often small and/or intricate parts needed is expensive), for overriding design flexibility limitations, for further weight reduction, and for providing un-restricted aesthetic possibilities, thanks to the colorability of the same. It is therefore desirable that plastic mobile electronic parts are made from materials that are easy to consistently process into various and complex shapes and have high impact performance to sustain the rigors of daily use, while not interfering with their intended operability (e.g. radio communications).

### DETAILED DESCRIPTION OF THE INVENTION

Described herein reinforced thermoplastic polymer compositions including a flat, low-dielectric glass (“D-glass”) fiber. D-glass fiber compositions with a flat morphology provide for polymer compositions having significantly reduced shrinkage and excellent mechanical and dielectric performance. The flat, D-glass fibers can be desirably incorporated into polyamide polymers, polyester polymers, poly(aryl ether sulfone) (“PAES”) polymers, poly(aryl ether ketone) (“PAEK”) polymers and polyphenylene sulfide (“PPS”) polymers.

Mobile electronic device application settings continually require more intricate and narrower polymeric components to keep pace with consumer demand for lighter and thinner mobile electronic devices, while maintaining high dielectric performance to support radio communications. However, such components still require the production consistency, mechanical performance and dielectric performance of larger mobile device components. In general injection molded polymer compositions including round glass fibers have significant anisotropic shrinkage, particularly when comparing shrinkage in the flow direction to the shrinkage in a direction transverse to the flow direction. Not only does the anisotropic shrinkage frustrate attempts at injection molding more intricate polymeric mobile electronic device components, but the resulting large anisotropy in the internal stress reduces mechanical performance (e.g. impact performance). Additionally, because mobile electronic device components generally include radio frequency transmission and reception systems, polymeric components having low dielectric constants are critical to mobile electronic devices.

By combining D-glass fiber compositions with a flat morphology, mobile electronic device components having improved mechanical performance and excellent dielectric performance, while having significantly reduced shrinkage can be achieved. Without being limited by a theory, D-glass fiber compositions generally have reduced density relative to E-glass fiber compositions. Accordingly, for the same mass and relative to E-glass fiber compositions, D-glass fiber compositions occupy a greater volume within the thermoplastic polymer matrix of the thermoplastic polymer composition. While flat glass fibers inherently provide for reduction in shrinkage in the transverse direction to flow during injection molding, combining the flat morphology with relatively low density D-glass fiber compositions can significantly further reduce the shrinkage. Concomitantly, reduced internal stresses and improved mechanical performance can be achieved, while having excellent dielectric performance. Moreover, due to the significantly reduced transverse shrinkage, production consistence is improved as shrinking is significantly more isotropic, with respect to the flow and transverse flow directions during injection molding.

The reinforced polymer compositions are described in detail below.

### The Glass Fiber

The polymer compositions described herein contain 10 wt. % to 90 wt. % of a flat D-glass fiber. As used herein, wt. % is relative to the total weight of the polymer composition unless explicitly indicated otherwise. The flat D-glass fibers comprise D-glass and have a flat morphology. In some embodiments, the concentration of the flat D-glass fiber is at least 20 wt. %, preferably at least 30 wt. %, more preferably at least 40 wt. %, even more preferably at least 50 wt. %, still more preferably at least 60 wt. %, most preferably at least 65 wt. %. In some embodiments, additionally or alternatively, the concentration of the flat D-glass fiber is no more than 85 wt. %, preferably no more than 80 wt. %, more preferably no more than 75 wt. %, most preferably no more than 70 wt. %. In some embodiments, the concentration of D-glass fiber is from 5 wt. % to 70 wt. %, preferably from 30 wt. % to 60 wt. %. It is well known that polymer compositions including higher concentrations of glass fiber have higher strength and specific modulus, relative to corresponding compositions having lower glass fiber concentrations. Accordingly, the person of ordinary skill in the art will know how to select a D-glass fiber concentration based on the intended application setting.

D-glass fiber is a low-dielectric glass fiber. In some embodiments, the D-glass fiber has a dielectric constant at 1 MHz of 4 to 6, preferably from 4 to 5, most preferably from 4 to 4.5. Additionally or alternatively, the D-glass fiber has a dielectric constant at 10 GHz of 4 to 5. The dielectric constant of the D-glass fiber can be measured according to ASTM D2520. In some embodiments, the D-glass fiber comprises the following components in the following concentrations:

TABLE 1

| | Concentration |
|---|---|
| Component | (wt. %) |
| SiO₂ | 50 to 76 |
| B₂O₃ | 8 to 30 |
| Al₂O₃ | 0 to 18 |
| TiO₂ | 0 to 5 |
| MgO | 0 to 10 |
| CaO | 0 to 8 |
| ZnO | 0 to 3 |
| Li₂O | 0 to 1.1 |
| Na₂O | 0 to 2 |
| K₂O | 0 to 2 |
| Fe₂O | 0 to 0.4 |
| F₂ | 0 to 2 |

The component concentrations in Table 1 are relative to the total weight of the D-glass fiber. In some embodiments, the selected concentrations sum to 100 wt. %.

As used herein, a flat D-glass fiber has a non-circular cross section. The cross-section is taken in a plane perpendicular to the length of the D-glass fiber and has a major dimension, corresponding to the longest dimension in the cross section, and minor dimension, the dimension of the fiber perpendicular to both the major dimension and the length. The non-circular cross section can be, for example but not limited to, oval, elliptical or rectangular. The aspect ratio (ratio of the major dimension to the minor dimension) of the flat D-glass fiber is at least 2:1. In some embodiments, the aspect ratio of the flat D-Glass fiber can be from 2:1 to 5:1. The aspect ratio can be measured according to ISO 1888. In embodiments, the major dimension is from 10 μm to 50 μm, preferably 25 μm to 31 μm, and the minor dimension is from 3 μm to 20 μm, preferably 6 μm to 8 μm.

In some embodiments, the flat D-glass fiber has a tensile strength from 1000 megapascals (“MPa”) to 5000 MPa, preferably from 2000 MPa to 2500 MPa. Additionally or alternatively, the flat D-glass fiber can have a tensile modulus of from 20 gigapascals (“GPa”) to 90 GPa, preferably from 50 GPa to 60 GPa. Tensile strength and tensile modulus can be measured according to ASTM D2343.

### The Polymers

In some embodiments, the thermoplastic polymer selected from the group consisting of a polyamide polymer, a polyester polymer, a PAES polymer, a PAEK polymer and a PPS polymer. In some embodiments, the concentration of the thermoplastic polymer is from 10 wt. % to 90 wt. %. In some embodiments, the concentration of the flat D-glass fiber is at least 15 wt. %, preferably at least 20 wt. %, more preferably at least 25 wt. %, most preferably at least 30 wt. %. In some embodiments, additionally or alternatively, the concentration of the flat D-glass fiber is no more than 80 wt. %, preferably no more than 70 wt. %, more preferably no more than 60 wt. %, even more preferably no more than 50 wt. %, still more preferably no more than 40 wt. %, most preferably no more than 35 wt. %. In some embodiments, the concentration of the flat D-glass fiber is from 5 wt. % to 95 wt. %, preferably from 10 wt. % to 80 wt. %, most preferably from 20 wt. % to 75 wt. %.

In some embodiments, the polymer composition can include a plurality of distinct thermoplastic polymers, where each thermoplastic polymer is selected from the group consisting of a polyamide polymer, a polyester polymer, a PAES polymer, a PAEK polymer and a PPS polymer. In such embodiments, the total concentration of thermoplastic polymers is within the ranges described above.

### The Polyamide Polymer

As noted above, in some embodiments, the thermoplastic polymer is a polyamide polymer. As used herein, a polyamide polymer refers to any polymer including at least 50 mole percent (“mol %”) of a recurring unit (R_{PA}) having at least one amide group (—C(═O)—NH—). In some embodiments, the polyamide has at least 60 mol %, preferably at least 70 mol %, more preferably at least 80 mol %, even more preferably at least 90 mol %, most preferably at least 99 mol % of recurring unit (R_{PA}), relative to the total number of moles of recurring units in the polyamide polymer.

Recurring unit (R_{PA}) is represented by the following formula:

—[—M_{A}—M_{B}]— (1)

where —M_{A}— is represented by a formula selected from the following group of formulae:

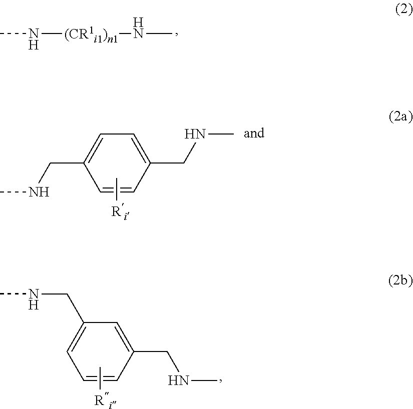

and where —M_{B}— is represented by a formula selected from the following group of formulae:

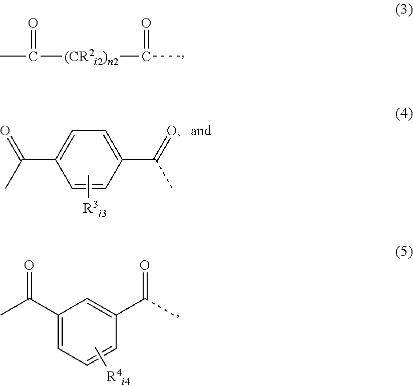

where R¹ to R⁴ and R′ and R″ at each instance, is independently selected from the group consisting of a halogen, an alkyl, an alkenyl, an ether, a thioether, an ester, an amide, an imide, an alkali or alkaline earth metal sulfonate, an alkyl sulfonate, an alkali or alkaline earth metal phosphonate, an alkyl phosphonate, an amine, and an quaternary ammonium; i₁ and i₂, at each instance, is an independently selected integer from 0 to 2; i′, i″, i₃ and i₄ are independently selected integers from 0 to 4; n₁ is integer from 4 to 12; and n₂ is an integer from 6 to 18. As used herein, a dashed bond (—) represents a bond to an atom outside the individual recurring unit.

In some embodiments M_{A} is represented by Formula (2) and M_{B} is represented by Formula (3). In some such embodiments i₁ to i₄ are zero. Additionally or alternatively, either n₁ is 5 or 6, n₃ is 10 or both. In some embodiments in which M_{A} is represented by Formula (2) and M_{B} is represented by Formula (3), the polyamide polymer is selected from the group consisting of PA4,6; PA5,6; PA6,6; PA4,10; PA5,10; PA6,10; PA1010; PA1012.

In some embodiments, M_{A} is represented by Formula (2) and M_{B} is represented by Formula (4) or (5). In some such embodiments, i₁ to i₄ are zero. Additionally or alternatively, n₁ is 4 to 10, preferably 6. In some embodiments in which M_{A} is represented by Formula (2) and M_{B} is represented by Formula (4) or (5), the polyamide is selected from the group consisting of PA4,T; PAS,T; PA6,T; PA8,T; PA9,T; PA10,T; PA4,I; PA5,I; PA6,I; PA8,I,T; PA9,I and PA10,I.

In some embodiments, M_{A} is represented by formula 2(a) or 2(b) and M_{b} is represented by Formula (3). In some such embodiments, i₂, i′ and i″ are all zero. Additionally or alternatively, n2 can be from 6 to 10, preferably 6 or 10. In some embodiments, in which M_{A} is represented by formula 2(a) or 2(b) and M_{b} is represented by Formula (3), the polyamide is selected from the group consisting of MXD6, MXD10, PXD6 and PXD10.

Of course, in some embodiments, the polyamide can include one or more additional recurring units (R*_{PA}). In such embodiments, each of the recurring units (R*_{PA}) is distinct from each other, and from recurring unit (R_{PA}), and is represented by Formulae (1) to (5) above. For clarity, in embodiments in which the polyamide polymer contains recurring units (R_{PA}) and (R*_{PA}), the total concentration of recurring units (R_{PA}) and (R*_{PA}) is at least 50 mol %, and, in some embodiments, the total concentration of recurring units (R_{PA}) and (R*_{PA}) in the polyamide polymer is at least 60 mol %, at least 70 mol, at least 80 mol %, at least 90 mol %, at least 95 mol %, or at least 99 mol %. In some embodiments, the molar ratio of recurring unit (R_{PA}):(R*_{PA}) is from 99:1 to 1:99, preferably from 80:20 to 20:80, more preferably 70:30 to 30:70, most preferably 60:40 to 40:60. In some embodiments, the polyamide is selected from the group consisting of PA6,T/6,I, PA6,T/6,I/6,6, and PA6,T/6,6.

In some embodiments, the polyamide polymer has an inherent viscosity of from 0.5 to 2.0 deciliters per gram (“dL/g”) ASTM D5336.

In some embodiments, the polyamide polymer has a melting point of from about 180° C. to 340° C. Melting point can be measured using differential scanning calorimetry (“DSC”) according to ISO-11357-3.

As noted above, in some embodiments, the polymer composition includes a plurality of distinct thermoplastic polymers. In some such embodiments, the polymer composition includes a plurality of distinct polyamide polymers, each having a distinct recurring unit (R*_{PA}), where recurring unit (R*_{PA}) is represented by a formulae above used to represent the various embodiments of recurring unit (R_{PA}). In embodiments including a plurality of distinct polyamide polymers, each of the polyamide polymers can have an inherent viscosity and melting point as described in the respective ranges above.

### The Polyester Polymer

As noted above, in some embodiments, the thermoplastic polymer is a polyester polymer. As used herein, a polyester polymer refers to any polymer containing, relative to the total number of recurring units in the polyester polymer, at least 50 mol % of a recurring unit (R_{PE}) which contains an ester group (—C(═O)—O—). In some embodiments, the polyester polymer includes at least 60 mol %, at least 70 mol %, at least 80 mol %, at least 90 mol %, at least 95 mol %, at least 99 mol % or at least 99.9 mol % of recurring unit (R_{PE}), relative to the total number of recurring units in the polyester polymer.

In some embodiment, recurring unit (R_{PE}) is represented by the following formula :

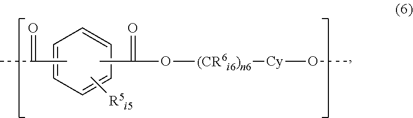

where R⁵ and R⁶, at each location, is independently selected from the group consisting of a halogen, an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine and a quaternary ammonium; Cy is a bond or a substituted cycloaliphatic group containing a monovalent alkyl group and monovalent cycloaliphatic group; i₅ is an integer from 0 to 4; i₆, at each location, is an independently selected integer from 0 to 2; and n₆ is an integer from 1 to 12.

In some embodiment, recurring unit (R_{PE}) is represented by the following formula:

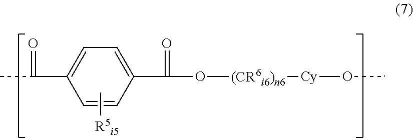

In some such embodiments, i₅ and i₆, at each location, is zero. In some embodiments, additionally, either Cy is a bond; n₆ is 2 or 4; or both. In some embodiments, the polyester polymer is polytrimethylene terephthalate (“PTT”) (i₅ and i₆, at each location, is 0; Cy is a bond; and n₆ is 1); polyethylene terephthalate (“PET”) (i₅ and i₆, at each location, is 0; Cy is a bond; and n₆ is 2), polybutylene terephthalate (“PBT”) (i₅ and i₆, at each location, is 0; Cy is a bond; and n₆ is 4).

In some embodiments in which recurring unit (R_{PE}) is represented by either Formula (6) or (7), Cy is represented by the following formula :

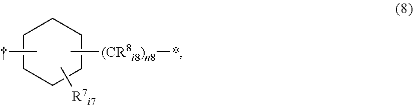

where R⁷ and R⁸, at each location, are independently selected from the group consisting a halogen, an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine and a quaternary ammonium; i₇ is an integer from 0 to 10; i₈, at each location, is an independently selected integer from 0 to 2; and n₈ is an integer from 1 to 12. Referring to Formula (8), “†” indicates a bond to the (CR⁶) group in Formulae (6) and (7). Similarly, “*” indicates a bond to the —O— group in Formulae (6) and (7). In some embodiments, in which recurring unit (R_{PE}) is represented by either Formula (6) or (7) and Cy is represented by Formula (8), —(CR⁶ᵢ₆)ₙ₆— is the same as —(CR⁸ᵢ₈)ₙ₈—. In some such embodiments, either n₆=n₈=1; i₆ and i₈, at each location, is zero; or both.

In some embodiments in which recurring unit (R_{PE}) is represented by either Formula (6) or (7), Cy is represented by the following formula:

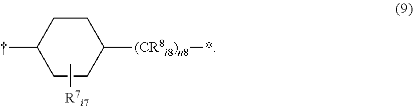

In some such embodiments, i₇ and i₈, at each location, is zero. In some embodiments, additionally or alternatively, —(CR⁶ᵢ₆)ₙ₆— is the same as —(CR⁸ᵢ₈)ₙ₈—. In some such embodiments, n₆=n₈=1.

In some embodiments, the polyester includes a plurality of distinct recurring units, where the total concentration of distinct recurring units is with the ranges specified above with respect to recurring unit (R_{PE}). In one such embodiment, the polyester polymer contains at least 50 mol % of recurring units formed from the polycondensation of the following three monomers : dimethyl terephthalate, 2,2,4,4,-tetramethyl-1,3,-cyclobutanediol and 1,4-clyclohexanedimethanol.

In some embodiments, the polyester polymer has an inherent viscosity of from 0.4 deciliters per gram (“dL/g”) to 2.0 dL/g, preferably 0.4 dL/g to 1.4 dL/g, as measured in a 60:40 phenol/tetrachloroethane mixture or similar solvent at 30° C. according to ASTM D5225.

In some embodiments, the polyester polymer has a melting point of at least 250° C., preferably at least 260° C., more preferably at least 270° C. and most preferably at least 280° C. In some embodiments, additionally or alternatively, the polyester polymer has a melting point of at most 350° C., preferably at most 340° C., more preferably at most 330° C. and most preferably at most 320° C. Melting point can be measured using differential scanning calorimetry (“DSC”) according to ISO-11357-3. In other embodiments, the polyester polymer is amorphous and, therefore, has a glass transition temperature but not a melting point.

As noted above, in some embodiments, the polymer composition includes a plurality of distinct thermoplastic polymers. In some such embodiments, the polymer composition includes a plurality of distinct polyester polymers, each having a distinct recurring unit (R*_{PE}), where recurring unit (R*_{PE}) is represented by a formulae above used to represent the various embodiments of recurring unit (R_{PE}). In embodiments including a plurality of distinct polyester polymers, each of the polyester polymers can have an inherent viscosity and melting point as described in the respective ranges above.

### Poly(Aryl Ether Sulfone) Polymers

As noted above, in some embodiments, the thermoplastic polymer is a PAES polymer. As used herein, a PAES polymer denotes any polymer containing at least 50 mol % of a recurring unit (R_{PAES}) represented by the formula:

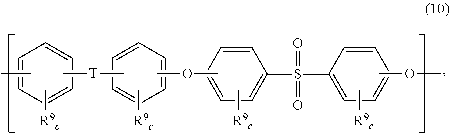

where R⁹, at each instance, is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; c, at each instance, is an independently selected integer from 0 to 4, preferably 0; and T is selected from the group consisting of a bond, a sulfone group [—S(═O)_{2—}], and a group —C(R^{10′})(R^{11′})—, where R^{10′} and R^{11′} are independently selected from the group consisting of a hydrogen, a halogen, an alkyl, an alkenyl, an alkynyl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium. R^{10′} and R^{11′} are preferably methyl groups. In some embodiments, the PAES polymer contains at least 60 mol %, at least 70 mol, at least 80 mol %, at least 90 mol %, at least 95 mol %, 99 mol % of recurring unit (R_{PAES}). In some embodiments, the PAES polymer is a polyphenylsulfone (“PPSU”) polymer. In such embodiments, recurring unit (R_{PAES}) is represented by the formula:

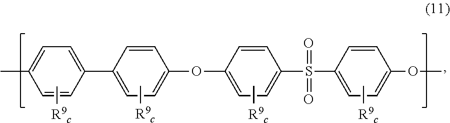

Preferably, d, at each instance, is 0.

In some embodiments, the PAES polymer is a polyethersulfone (“PES”) polymer. In such embodiments, recurring unit (R_{PAES}) is represented by the formula:

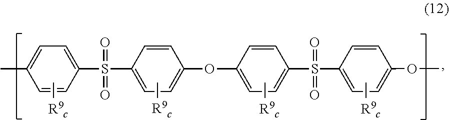

Preferably c, at each instance is 0.

In some embodiments, the PAES polymer is a polysulfone (“PSU”) polymer. In such embodiments, recurring unit (R_{PAES}) is represented by the formula:

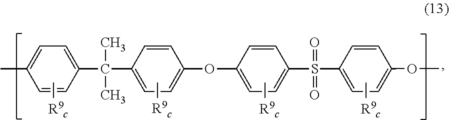

Preferably c, at each instance, is 0.

As noted above, in some embodiments, the polymer composition includes a plurality of distinct thermoplastic polymers. In some such embodiments, the polymer composition includes a plurality of distinct PAES polymers, each having a distinct recurring unit (R*_{PAES}), where recurring unit (R*_{PAES}) is represented by a formulae above used to represent the various embodiments of recurring unit (R_{PAES}).

### The Poly(Aryl Ether Ketone) Polymer

As noted above, in some embodiments, the thermoplastic polymer is a PAEK polymer. As used herein, a PAEK polymer denotes any polymer containing at least 50 mol % of a recurring unit (R_{PAEK}) represented by a formula selected from the following of group of formulae:

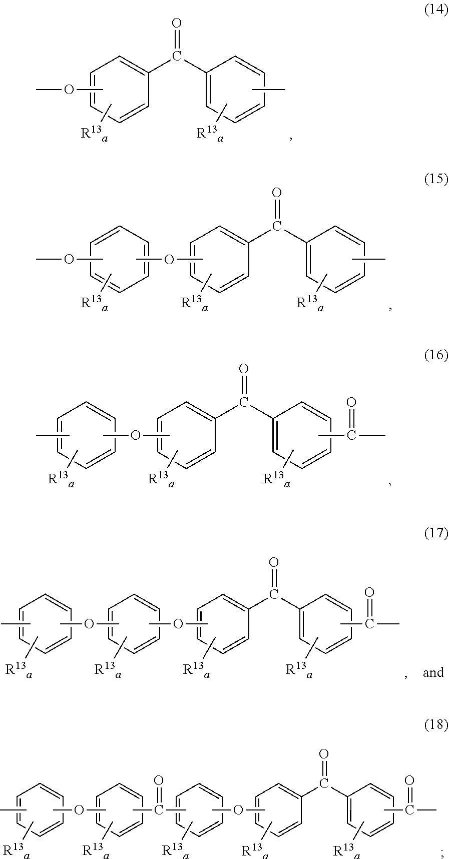

where R¹³, at each instance, is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and a, at each instance, is an independently selected integer from 0 to 4. Preferably, each a is 0. Preferably, the phenylene moieties in recurring unit (R_{PAES}) have 1,3- or 1,4-linkages. In some embodiments, the PAEK polymer contains at least 60 mol %, at least 70 mol, at least 80 mol %, at least 90 mol %, at least 95 mol %, 99 mol % of recurring unit (R_{PAEK}).

In some embodiments, the PAEK polymer is a poly(ether ketone) (“PEK”) polymer. In such embodiments, recurring unit (R_{PAEK}) is represented by the formula:

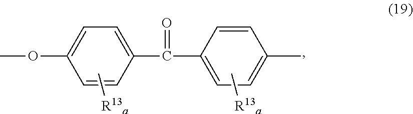

preferably, each a is 0.

In some embodiments, the PAEK polymer is a poly(ether ether ketone) (“PEEK”). In such embodiments, recurring unit (R_{PAEK}) is represented by the formula :

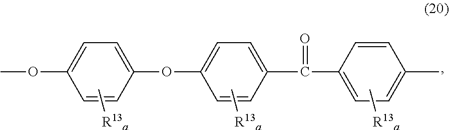

preferably, each a is 0.

In some embodiments, the PAEK polymer is a poly(ether ketone ketone) (“PEKK”). In such embodiments, the PEAK polymer includes recurring unit (R_{PAEK}) and recurring unit (R*_{PAEK}), respectively represented by the following formulae:

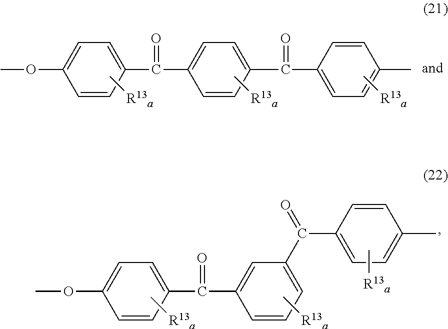

Preferably, a, at each instance and in each of Formulae (21) and (22), is 0. For clarity, in embodiments in which the PAEK polymer is PEKK polymer, the total concentration of recurring units (R_{PAEK}) and (R*_{PAEK}) is at least 50 mol %, and, in some embodiments, the total concentration of recurring units (R_{PAEK}) and (R*_{PAEK}) in the PEKK polymer is at least 60 mol %, at least 70 mol, at least 80 mol %, at least 90 mol %, at least 95 mol %, or at least 99 mol %. In some embodiments, the molar ratio of recurring unit (R_{PAEK}):(R*_{PAEK}) is from 50:50 to 85:15, preferably from 55:45 to 80:20, more preferably from 65:35 to 75:25.

In some embodiments, the PAEK polymer is poly(ether ether ketone ketone) (“PEEKK”) polymer. In such embodiments, recurring unit (R_{PAEK}) is represented by the following formula:

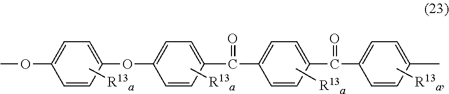

preferably, a, at each instance, is 0.

In some embodiments, the PAEK polymer is poly(ether ketone ether ketone ketone) (“PEKEKK”) polymer. In such embodiments, recurring unit (R_{PAEK}) is represented by the following formula:

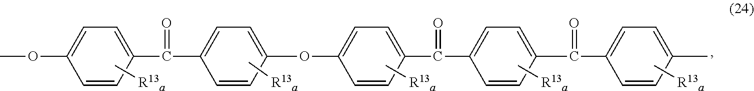

where R¹⁸, at each instance, is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and k, at each instance, is an independently selected integer from 0 to 4. Preferably, each k is 0.

As noted above, in some embodiments, the polymer composition includes a plurality of distinct thermoplastic polymers. In some such embodiments, the polymer composition includes a plurality of distinct PAEK polymers, each having a distinct recurring unit (R*_{PAEK}), where recurring unit (R*_{PAEK}) is represented by a formulae above used to represent the various embodiments of recurring unit (R_{PAEK}).

### The Polyphenylene Sulfide Polymer

As noted above, in some embodiments, the thermoplastic polymer is a PPS polymer. As used herein, a PPS polymer denotes any polymer containing at least 50 mol % of a recurring unit (R_{PPS}) represented by the following formula:

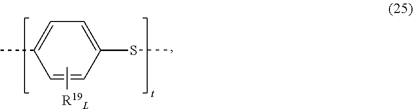

where R¹⁹, at each location, is independently selected from the group consisting of an alkyl, an aryl, an alkoxy, an aryloxy, an alkylketone, an arylketone, a fluoroalkyl, a fluoroaryl, a bromoalkyl, a bromoaryl, a chloroalkyl, a chloroaryl, an alkylsulfone, an arylsulfone, an alkylamide, an arylamide, an alkylester, an arylester, a fluorine, a chlorine, and a bromine; L is an integer from 0 to 4, preferably 0; and t is an integer greater than 50, preferably greater than 100. In some embodiments, the concentration of recurring unit (R_{PPS}) is at least 60 mol %, at least 70 mol %, at least 80 mol %, at least 90 mol %, at least 95 mol % or at least 99 mol %.

As noted above, in some embodiments, the polymer composition includes a plurality of distinct thermoplastic polymers. In some such embodiments, the polymer composition includes a plurality of distinct PPS polymers, each having a distinct recurring unit (R*_{PPS}), where recurring unit (R*_{PPS}) is represented by a formulae above used to represent the various embodiments of recurring unit (R_{PPS}).

### Articles

Due to the outstanding combination of dielectric and mechanical properties, the reinforced thermoplastic polymer compositions can be desirably incorporated into a wide variety of articles. Most desirably, the reinforced thermoplastic polymer compositions described herein can be advantageously incorporated into mobile electronic device components. As used herein, a “mobile electronic device” refers to an electronic device that is intended to be conveniently transported and used in various locations. A mobile electronic device can include, but is not limited to, a mobile phone, a personal digital assistant (“PDA”), a laptop computer, a tablet computer, a wearable computing device (e.g., a smart watch, smart glasses and the like), a camera, a portable audio player, a portable radio, global position system receivers, and portable game consoles.

The mobile electronic devices of interest herein contain at least one radio antenna, configured to send or receive radio signals. To transmit radio signals, the mobile electronic device converts data into a radio signal and transmits the radio signal through the antenna. To receive radio signals, the mobile electronic receives a radio signal through the antenna and decodes the radio signal into data. In one embodiment, the radio antenna can be a WiFi antenna. In some embodiments, the WiFi antenna transmits or receives radio signals having a 2.4 GHz or 5.0 GHz frequency. In other embodiments, the radio antenna can be a radio frequency identification (“RFID”) antenna, including but not limited to, a near-field communication (“NFC”) antenna. In some embodiments, the RFID antenna transmits or receives radio signals having a frequency of from 125 kHz to 134 kHz, 13.56 MHz or from 856 MHz to 960 MHz.

In some embodiments, at least a portion of the mobile electronic device can be exposed to the external environment of the mobile electronic device (e.g., at least a portion of the component is in contact with the environment external to the mobile electronic device). For example, at least a portion of the device component can form at least a portion of the external housing of the mobile electronic device. In some such embodiments, the device component can be a full or partial “frame” around the periphery of the mobile electronic device, a beam in the form of a lattice work, or a combination thereof. As another example, at least a portion of the device component can form at least a portion of an input device. In some such embodiments, a button of the electronic device can include the device component. In some embodiments, the device component can be fully enclosed by the electronic device (e.g., the device component is not visible from an observation point external to the mobile electronic device).

In some embodiments, the mobile electronic device component is an antenna housing. In some such embodiments, at least a portion of the radio antenna is disposed on the aliphatic polyamide composition. Additionally or alternatively, at least a portion of the radio antenna can be displaced from the aliphatic polyamide composition by no more than 50 cm, no more than 30 cm, no more than 15 cm, no more than 10 cm, no more than 5 cm, no more than 1 cm, no more than 10 mm, no more than 5 mm, no more than 1 mm or no more than 0.5 mm. In some embodiments, the device component can be of a mounting component with mounting holes or other fastening device, including but not limited to, a snap fit connector between itself and another component of the mobile electronic device, including but not limited to, a circuit board, a microphone, a speaker, a display, a battery, a cover, a housing, an electrical or electronic connector, a hinge, a radio antenna, a switch, or a switchpad. In some embodiments, the mobile electronic device can be at least a portion of an input device.

The device components of the mobile electronic device can be fabricated using methods well known in the art. For example, the mobile electronic device components can be fabricated by methods including, but not limited to, injection molding, blow molding or extrusion molding.

In some embodiments, the polyamide compositions can be formed into pellets (e.g., having a substantially cylindrical body between two ends) by methods known in the art including, but not limited to, injection molding. In some such embodiments, mobile electronic device components can be fabricated from the pellets.

In some embodiments, the mobile electronic device components can be coated with metal by methods well known in the art, including but not limited to, vacuum deposition (including various methods of heating the metal to be deposited), electroless plating, electroplating, chemical vapor deposition, metal sputtering, and electron beam deposition. Although the metal may adhere well to the device components without any special treatment, in some embodiments, methods well known in the art can be used to improve adhesion. Such methods include, but are not limited to, abrasion to roughen the synthetic resin surface, addition of adhesion promotion agents, chemical etching, functionalization of the surface by exposure to plasma and/or radiation (for instance laser or UV radiation) or any combination of these. Also, in some embodiments, metal coating methods can include at least one step where the mobile electronic device component is immersed in an acid bath. More than one metal or metal alloy can be plated onto the device components containing the polyamide composition. For example, one metal or alloy can be plated directly onto the synthetic resin surface because of its good adhesion, and another metal or alloy can be plated on top of the previous plating because it has a higher strength and/or stiffness. Useful coating metals and alloys include, but are not limited to, copper, nickel, iron-nickel, cobalt, cobalt-nickel, and chromium, and combinations of these in distinct layers. In some embodiments, the surface of the mobile electronic device component can be fully or partially coated with metal. In some embodiments, more than about 50% or about 100% of the surface area of the device component can be metal coated. In different areas of the device component the thickness and/or the number of metal layers, and/or the composition of the metal layers may vary. The metal may be coated in patterns to efficiently improve one or more properties in certain sections of the mobile electronic device component.

### Further Inventive Concepts

Described below are specific, non-limiting embodiments of the present invention. The person of ordinary skill in the art will recognize that each combination of the elements of any linked inventive concepts, including any explicitly described species within an explicitly described genus and any value within an explicitly stated range, is specifically contemplated and within the scope of the present disclosure. Furthermore, in the inventive concepts below, the person of ordinary skill in the art will understand that, based upon the disclosure above, dielectric constant is measured according to ASTM D2520 and both tensile strength and tensile modulus are measured according to ASTM D2343.

1. A reinforced thermoplastic polymer composition comprising:
a thermoplastic polymer selected from the group consisting of a polyamide polymer, polyester polymer, a poly(aryl ether sulfone) (“PAES”) polymer, a poly(aryl ether ketone) (“PAEK”) polymer and a polyphenylene sulfide (“PPS”) polymer; and
20 wt. % to 85 wt. %, relative to the total weight of the reinforced thermoplastic polymer composition, of a flat D-glass fiber comprising an aspect ratio of from 2:1 to 5:1,

wherein
wherein the flat D-glass fiber has a dielectric constant at 1 MHz of 4 to 6, preferably from 4 to 5, most preferably from 4 to 4.5.

2. The thermoplastic polymer composition of inventive concept 1, wherein the thermoplastic polymer is a polyamide polymer.

3. The thermoplastic polymer composition of inventive concept 2, wherein the polyamide polymer comprises at least 50 mol % of a recurring unit (R_{PA}), recurring unit recurring unit (R_{PA}) represented by the following formula:

—[—M_{A}—M_{B}—]— (1)

where —M_{A}— is represented by the formula:

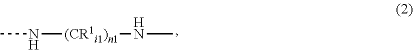

and
where —M_{B}— is represented by a formula selected from the following group of formulae:

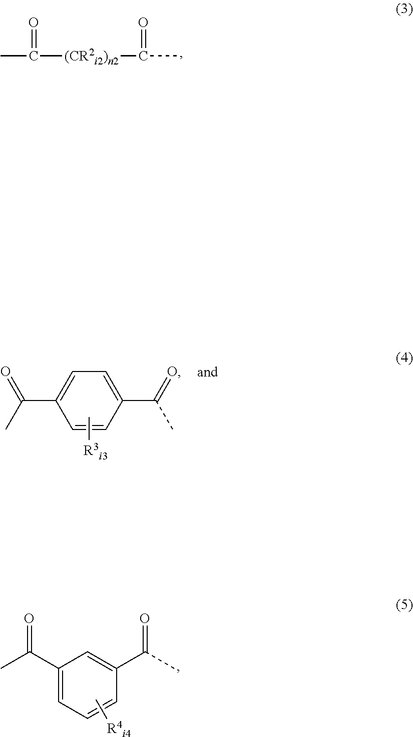

and

wherein
R¹ to R⁴, at each instance, is independently selected from the group consisting of a halogen, an alkyl, an alkenyl, an ether, a thioether, an ester, an amide, an imide, an alkali or alkaline earth metal sulfonate, an alkyl sulfonate, an alkali or alkaline earth metal phosphonate, an alkyl phosphonate, an amine, and an quaternary ammonium;
i₁ and i₂, at each instance, is an independently selected integer from 0 to 2;
i₃ and i₄ are independently selected integers from 0 to 4; and
n₁ is integer from 4 to 12,
n₂ is integer from 6 to 18,
preferably i₁ and i₂, at each instance, and i₃ and i₄ are all zero.

4. The thermoplastic polymer composition of inventive concept 3, wherein M_{A} is represented by Formula (2) and M_{B} is represented by Formula (3), preferably i₁ and i₂, at each instance, are all zero.

5. The thermoplastic polymer composition of inventive concept 4, wherein the polyamide polymer is selected from the group consisting of PA4,6; PA5,6; PA6,6; PA4,10; PA5,10; PA6,10; PA1010; PA1012.

6. The reinforced thermoplastic composition of inventive concept 5, wherein the D-Glass fiber comprises:
50 to 76 wt. % of SiO₂,
8 to 30 wt. % of B₂O₃,
0 to 18 wt. % of Al₂O₃,
0 to 5 wt. % of TiO₂,
0 to 10 wt. % of MgO,
0 to 8 wt. % of CaO,
0 to 3 wt. % of ZnO,
0 to 1.1 wt. % of Li₂O,
0 to 2 wt. % of Na₂O,
0 to 2 wt. % of K₂O,
0 to 0.4 wt. % of Fe₂O, and
0 to 2 wt. % of F₂; and

wherein wt. % is relative to the total weight of the D-glass fiber.

7. The reinforced thermoplastic polymer composition of inventive concept 6, wherein the D-glass fiber has a dielectric constant at 10 GHz of 4 to 5.

8. The thermoplastic polymer composition of inventive concept 3, wherein M_{A} is represented by Formula (2) and M_{B} is represented by Formula (4) or (5), preferably i₁, at each instance, and i₃ and i₄ are all zero.

9. The thermoplastic polymer composition of inventive concept 8, wherein M_{B} is represented by Formula (4), preferably i₁, at each instance, and i₃ are all zero.

10. The thermoplastic polymer composition of inventive concept 9, wherein the polyamide polymer is selected from the group consisting of PA4,T; PAS,T; PA6,T; PA8,T; PA9,T; and PA10,T.

11. The reinforced thermoplastic composition of inventive concept 10, wherein the D-Glass fiber comprises
50 to 76 wt. % of SiO₂
8 to 30 wt. % of B₂O₃
0 to 18 wt. % of Al₂O₃
0 to 5 wt. % of TiO₂
0 to 10 wt. % of MgO
0 to 8 wt. % of CaO
0 to 3 wt. % of ZnO
0 to 1.1 wt. % of Li₂O
0 to 2 wt. % of Na₂O
0 to 2 wt. % of K₂O
0 to 0.4 wt. % of Fe₂O
0 to 2 wt. % of F₂

wherein wt. % is relative to the total weight of the D-glass fiber.

12. The reinforced thermoplastic polymer composition of inventive concept 11, wherein the D-glass fiber has a dielectric constant at 10 GHz of 4 to 5.

13. The thermoplastic polymer composition of inventive concept 3, wherein M_{B} is represented by Formula (5), preferably i₁, at each instance, and i₄ are all zero.

14. The thermoplastic polymer composition of inventive concept 13, wherein the thermoplastic polyamide is selected from the group consisting of PA4,I; PAS,I; PA6,I; PA8,I; PA9,I and PA10,I.

15. The reinforced thermoplastic composition of inventive concept 14, wherein the D-Glass fiber comprises
50 to 76 wt. % of SiO₂
8 to 30 wt. % of B₂O₃
0 to 18 wt. % of Al₂O₃
0 to 5 wt. % of TiO₂
0 to 10 wt. % of MgO
0 to 8 wt. % of CaO
0 to 3 wt. % of ZnO
0 to 1.1 wt. % of Li₂O
0 to 2 wt. % of Na₂O
0 to 2 wt. % of K₂O
0 to 0.4 wt. % of Fe₂O
0 to 2 wt. % of F₂

wherein wt. % is relative to the total weight of the D-glass fiber.

16. The reinforced thermoplastic polymer composition of inventive concept 15, wherein the D-glass fiber has a dielectric constant at 10 GHz of 4 to 5.

17. The thermoplastic polymer composition of inventive concept 3, wherein M_{B} is represented by Formula (4) and wherein the polyamide polymer further comprises a recurring unit (R*_{PA}) represented by Formula (1), wherein M_{b} is represented by Formula (5), preferably i₁, at each instance, and i₃ and i₄ are all zero.

18. The thermoplastic polymer composition of inventive concept 17, wherein the polyamide is selected from the group consisting of PA6,T/6,I, PA6,T/6,I/6,6, and PA6,T/6,6.

19. The reinforced thermoplastic composition of inventive concept 18, wherein the D-Glass fiber comprises
50 to 76 wt. % of SiO₂
8 to 30 wt. % of B₂O₃
0 to 18 wt. % of Al₂O₃
0 to 5 wt. % of TiO₂
0 to 10 wt. % of MgO
0 to 8 wt. % of CaO
0 to 3 wt. % of ZnO
0 to 1.1 wt. % of Li₂O
0 to 2 wt. % of Na₂O
0 to 2 wt. % of K₂O
0 to 0.4 wt. % of Fe₂O
0 to 2 wt. % of F₂

wherein wt. % is relative to the total weight of the D-glass fiber.

20. The reinforced thermoplastic polymer composition of inventive concept 19, wherein the D-glass fiber has a dielectric constant at 10 GHz of 4 to 5.

21. The thermoplastic polymer composition of inventive concept 1, wherein the thermoplastic polymer is a polyester polymer.

22. The thermoplastic polymer composition of inventive concept 21, wherein the polyester polymer comprises at least 50 mol % of a recurring unit (R_{PE}) represented by the following formula:

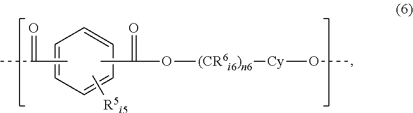

wherein
R⁵ and R⁶, at each location, is independently selected from the group consisting of a halogen, an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine and a quaternary ammonium;
Cy is a bond or a substituted cycloaliphatic group containing a monovalent alkyl group and monovalent cycloaliphatic group;
i₅ is an integer from 0 to 4;
i₆, at each instance, is an independently selected integer from 0 to 2; and
n₆ is an integer from 1 to 12,
preferably i₅ and i₆, at each instance, are all zero.

23. The thermoplastic polymer composition of inventive concept 22, wherein recurring unit (R_{PE}) is represented by the following formula:

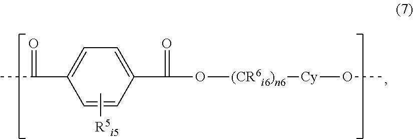

Preferably, i₅ and i₆, at each instance, are all zero.

24. The thermoplastic polymer composition of inventive concept 23, wherein the polyester polymers is selected from the group consisting of a polytrimethylene terephthalate polymer, a polyethylene terephthalate polymer, and a polybutylene terephthalate polymer.

25. The reinforced thermoplastic composition of inventive concept 24, wherein the D-Glass fiber comprises:
50 to 76 wt. % of SiO₂,
8 to 30 wt. % of B₂O₃,
0 to 18 wt. % of Al₂O₃,
0 to 5 wt. % of TiO₂,
0 to 10 wt. % of MgO,
0 to 8 wt. % of CaO,
0 to 3 wt. % of ZnO,
0 to 1.1 wt. % of Li₂O,
0 to 2 wt. % of Na₂O,
0 to 2 wt. % of K₂O,
0 to 0.4 wt. % of Fe₂O, and
0 to 2 wt. % of F₂; and

wherein wt. % is relative to the total weight of the D-glass fiber.

26. The reinforced thermoplastic polymer composition of inventive concept 25, wherein the D-glass fiber has a dielectric constant at 10 GHz of 4 to 5.

27. The reinforced thermoplastic polymer composition of inventive concept 23, wherein Cy is represented by the following formula:

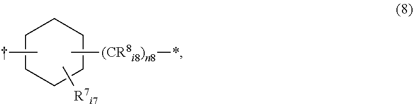

wherein
R⁷ and R⁸, at each location, are independently selected from the group consisting a halogen, an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine and a quaternary ammonium;
i₇ is an integer from 0 to 10;
i₈, at each location, is an independently selected integer from 0 to 2; and
n₈ is an integer from 1 to 12,
preferably i₅, i₇, and i₆ and i₈, at each instance, are all zero.

28. The thermoplastic polymer composition of inventive concept 27, wherein recurring unit (R_{PE}) is represented by the following formula:

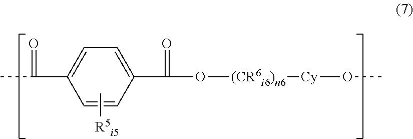

and

wherein Cy is represented by the following formula:

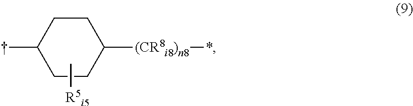

preferably i₅, i₇, and i₆ and i₈, at each instance, are all zero.

29. The reinforced thermoplastic composition of inventive concept 28, wherein —(CR⁶ᵢ₆)ₙ₆— is the same as —(CR⁸ᵢ₈)ₙ₈—, preferably i₅, i₇, and i₆ and i₈, at each instance, are all zero.

30. The reinforced thermoplastic composition of inventive concept 29, wherein the D-Glass fiber comprises:
50 to 76 wt. % of SiO₂,
8 to 30 wt. % of B₂O₃,
0 to 18 wt. % of Al₂O₃,
0 to 5 wt. % of TiO₂,
0 to 10 wt. % of MgO,
0 to 8 wt. % of CaO,
0 to 3 wt. % of ZnO,
0 to 1.1 wt. % of Li₂O,
0 to 2 wt. % of Na₂O,
0 to 2 wt. % of K₂O,
0 to 0.4 wt. % of Fe₂O, and
0 to 2 wt. % of F₂; and

wherein wt. % is relative to the total weight of the D-glass fiber.

31. The reinforced thermoplastic polymer composition of inventive concept 30, wherein the D-glass fiber has a dielectric constant at 10 GHz of 4 to 5.

32. The reinforced thermoplastic polymer composition of inventive concept 31, wherein n₆=n₈=1.

33. The reinforced thermoplastic polymer composition of inventive concept 1, wherein the thermoplastic polymer is a PAES polymer comprising at least 50 mol % of a recurring unit (R_{PAES}) represented by the formula

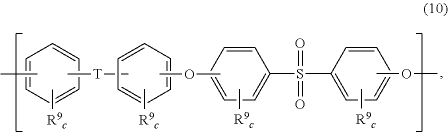

wherein
R⁹, at each instance, is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
c, at each instance, is an independently selected integer from 0 to 4, preferably 0; and
T is selected from the group consisting of a bond, a sulfone group [—S(═O)_{2—}], and a group —C(R^{10′})(R^{11′})—, where R^{10′} and R^{11—}, are independently selected from the group consisting of a hydrogen, a halogen, an alkyl, an alkenyl, an alkynyl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine, and a quaternary ammonium, preferably R^{10′} and R^{11′} are methyl groups.

34. The reinforced thermoplastic composition of inventive concept 33, wherein recurring unit (R_{PAES}) is represented by the formula:

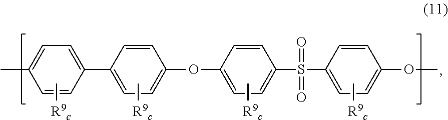

preferably c, at each instance, is zero.

35. The reinforced thermoplastic composition of inventive concept 34, wherein the D-Glass fiber comprises:
50 to 76 wt. % of SiO₂,
8 to 30 wt. % of B₂O₃,
0 to 18 wt. % of Al₂O₃,
0 to 5 wt. % of TiO₂,
0 to 10 wt. % of MgO,
0 to 8 wt. % of CaO,
0 to 3 wt. % of ZnO,
0 to 1.1 wt. % of Li₂O,
0 to 2 wt. % of Na₂O,
0 to 2 wt. % of K₂O,
0 to 0.4 wt. % of Fe₂O, and
0 to 2 wt. % of F₂; and

wherein wt. % is relative to the total weight of the D-glass fiber.

36. The reinforced thermoplastic polymer composition of inventive concept 35, wherein the D-glass fiber has a dielectric constant at 10 GHz of 4 to 5.

37. The reinforced thermoplastic polymer composition of inventive concept 33, wherein recurring unit (R_{PAES}) is represented by the formula:

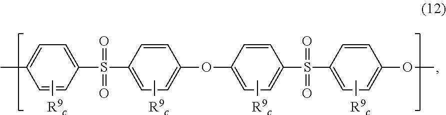

preferably c, at each instance, is zero.

38. The reinforced thermoplastic composition of inventive concept 37, wherein the D-Glass fiber comprises:
50 to 76 wt. % of SiO₂,
8 to 30 wt. % of B₂O₃,
0 to 18 wt. % of Al₂O₃,
0 to 5 wt. % of TiO₂,
0 to 10 wt. % of MgO,
0 to 8 wt. % of CaO,
0 to 3 wt. % of ZnO,
0 to 1.1 wt. % of Li₂O,
0 to 2 wt. % of Na₂O,
0 to 2 wt. % of K₂O,
0 to 0.4 wt. % of Fe₂O, and
0 to 2 wt. % of F₂; and

wherein wt. % is relative to the total weight of the D-glass fiber.

39. The reinforced thermoplastic polymer composition of inventive concept 38, wherein the D-glass fiber has a dielectric constant at 10 GHz of 4 to 5.

40. The reinforced thermoplastic polymer composition of inventive concept 33, wherein recurring unit (R_{PAES}) is represented by the formula:

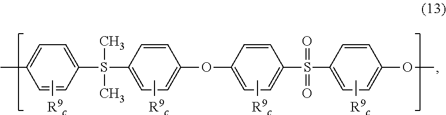

preferably, c, at each instance, is 0.

41. The reinforced thermoplastic composition of inventive concept 40, wherein the D-Glass fiber comprises:
50 to 76 wt. % of SiO₂,
8 to 30 wt. % of B₂O₃,
0 to 18 wt. % of Al₂O₃,
0 to 5 wt. % of TiO₂,
0 to 10 wt. % of MgO,
0 to 8 wt. % of CaO,
0 to 3 wt. % of ZnO,
0 to 1.1 wt. % of Li₂O,
0 to 2 wt. % of Na₂O,
0 to 2 wt. % of K₂O,
0 to 0.4 wt. % of Fe₂O, and
0 to 2 wt. % of F₂; and

wherein wt. % is relative to the total weight of the D-glass fiber.

42. The reinforced thermoplastic polymer composition of inventive concept 41, wherein the D-glass fiber has a dielectric constant at 10 GHz of 4 to 5.

43. The reinforced thermoplastic polymer composition of inventive concept 1, wherein the thermoplastic polymer is a PAEK polymer comprising at least 50 mol % of a recurring unit (R_{PAEK}) represented by a formula selected from the following of group of formulae:

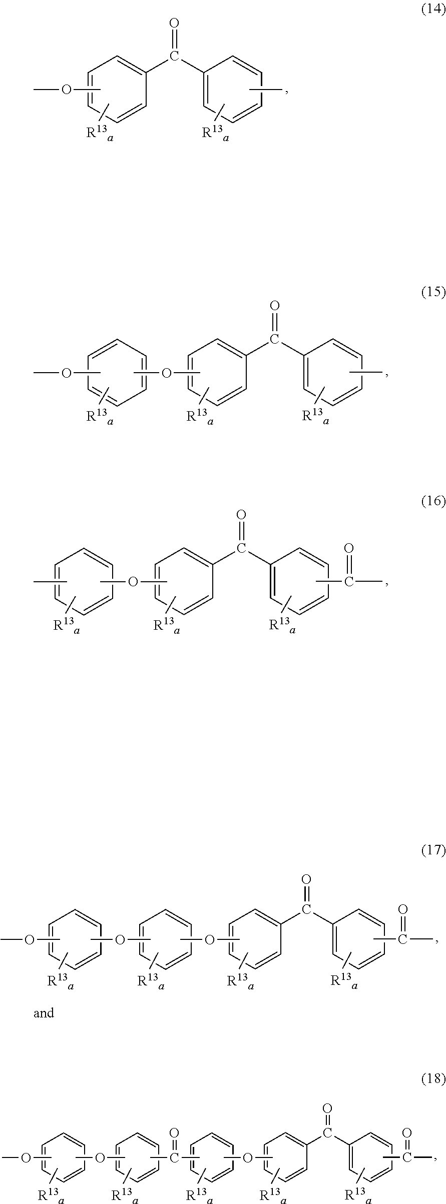

wherein
R¹³, at each instance, is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
a, at each instance, is an independently selected integer from 0 to 4, preferably 0.

44. The reinforced thermoplastic composition of inventive concept 43, wherein recurring unit (R_{PAEK}) is represented by the formula:

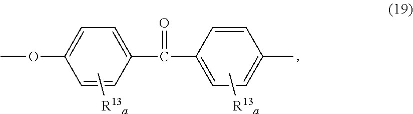

preferably, a, at each instance, is 0.

45. The reinforced thermoplastic composition of inventive concept 44, wherein the D-Glass fiber comprises:
50 to 76 wt. % of SiO₂,
8 to 30 wt. % of B₂O₃,
0 to 18 wt. % of Al₂O₃,
0 to 5 wt. % of TiO₂,
0 to 10 wt. % of MgO,
0 to 8 wt. % of CaO,
0 to 3 wt. % of ZnO,
0 to 1.1 wt. % of Li₂O,
0 to 2 wt. % of Na₂O,
0 to 2 wt. % of K₂O,
0 to 0.4 wt. % of Fe₂O, and
0 to 2 wt. % of F₂; and

wherein wt. % is relative to the total weight of the D-glass fiber.

46. The reinforced thermoplastic polymer composition of inventive concept 45, wherein the D-glass fiber has a dielectric constant at 10 GHz of 4 to 5.

47. The reinforced thermoplastic polymer composition of inventive concept 43, wherein recurring unit (R_{PAEK}) is represented by the formula:

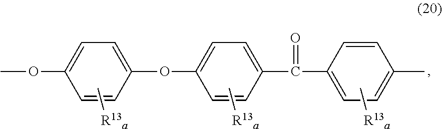

preferably, a, at each instance, is zero.

48. The reinforced thermoplastic composition of inventive concept 47, wherein the D-Glass fiber comprises:
50 to 76 wt. % of SiO₂,
8 to 30 wt. % of B₂O₃,
0 to 18 wt. % of Al₂O₃,
0 to 5 wt. % of TiO₂,
0 to 10 wt. % of MgO,
0 to 8 wt. % of CaO,
0 to 3 wt. % of ZnO,
0 to 1.1 wt. % of Li₂O,
0 to 2 wt. % of Na₂O,
0 to 2 wt. % of K₂O,
0 to 0.4 wt. % of Fe₂O, and
0 to 2 wt. % of F₂; and

wherein wt. % is relative to the total weight of the D-glass fiber.

49. The reinforced thermoplastic polymer composition of inventive concept 48, wherein the D-glass fiber has a dielectric constant at 10 GHz of 4 to 5.

50. The reinforced thermoplastic polymer composition of inventive concept 43, wherein the thermoplastic polymer further comprises recurring unit (R*_{PAEK}) and wherein recurring unit (R_{PAEK}) and recurring unit (R*_{PAEK}) are respectively represented by the following formulae:

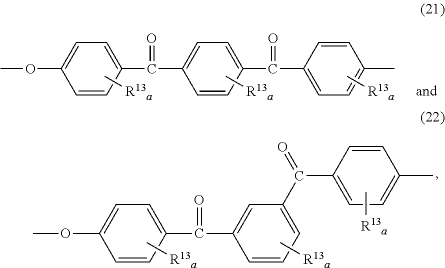

preferably, a, at each instance and in each of Formulae (21) and (22), is 0.

51. The reinforced thermoplastic composition of inventive concept 50, wherein the D-Glass fiber comprises:
50 to 76 wt. % of SiO₂,
8 to 30 wt. % of B₂O₃,
0 to 18 wt. % of Al₂O₃,
0 to 5 wt. % of TiO₂,
0 to 10 wt. % of MgO,
0 to 8 wt. % of CaO,
0 to 3 wt. % of ZnO,
0 to 1.1 wt. % of Li₂O,
0 to 2 wt. % of Na₂O,
0 to 2 wt. % of K₂O,
0 to 0.4 wt. % of Fe₂O, and
0 to 2 wt. % of F₂; and

wherein wt. % is relative to the total weight of the D-glass fiber.

52. The reinforced thermoplastic polymer composition of inventive concept 51, wherein the D-glass fiber has a dielectric constant at 10 GHz of 4 to 5.

53. The reinforced thermoplastic polymer composition of inventive concept 43, wherein recurring unit (R_{PAEK}) is represented by the following formula:

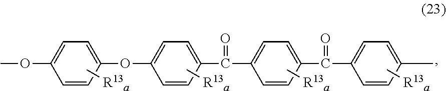

preferably, a, at each location, is 0.

54. The reinforced thermoplastic composition of inventive concept 53, wherein the D-Glass fiber comprises:
50 to 76 wt. % of SiO₂,
8 to 30 wt. % of B₂O₃,
0 to 18 wt. % of Al₂O₃,
0 to 5 wt. % of TiO₂,
0 to 10 wt. % of MgO,
0 to 8 wt. % of CaO,
0 to 3 wt. % of ZnO,
0 to 1.1 wt. % of Li₂O,
0 to 2 wt. % of Na₂O,
0 to 2 wt. % of K₂O,
0 to 0.4 wt. % of Fe₂O, and
0 to 2 wt. % of F₂; and

wherein wt. % is relative to the total weight of the D-glass fiber.

55. The reinforced thermoplastic polymer composition of inventive concept 54, wherein the D-glass fiber has a dielectric constant at 10 GHz of 4 to 5.

56. The reinforced thermoplastic polymer composition of inventive concept 43, wherein recurring unit (R_{PAEK}) is represented by the following formula:

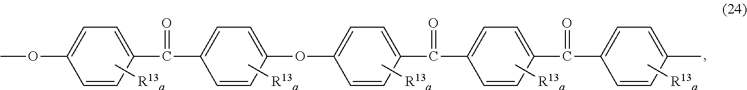

preferably a, at each location, is zero.

57. The reinforced thermoplastic composition of inventive concept 56, wherein the D-Glass fiber comprises:
50 to 76 wt. % of SiO₂,
8 to 30 wt. % of B₂O₃,
0 to 18 wt. % of Al₂O₃,
0 to 5 wt. % of TiO₂,
0 to 10 wt. % of MgO,
0 to 8 wt. % of CaO,
0 to 3 wt. % of ZnO,
0 to 1.1 wt. % of Li₂O,
0 to 2 wt. % of Na₂O,
0 to 2 wt. % of K₂O,
0 to 0.4 wt. % of Fe₂O, and
0 to 2 wt. % of F₂; and

wherein wt. % is relative to the total weight of the D-glass fiber.

58. The reinforced thermoplastic polymer composition of inventive concept 57, wherein the D-glass fiber has a dielectric constant at 10 GHz of 4 to 5.

59. The reinforced thermoplastic polymer composition of inventive concept 1, wherein the polymer is a PPS polymer comprising at least 50 mol % of a recurring unit (R_{PPS}) represented by the following formula:

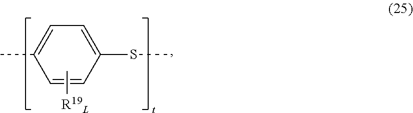

wherein
R¹⁹, at each location, is independently selected from the group consisting of an alkyl, an aryl, an alkoxy, an aryloxy, an alkylketone, an arylketone, a fluoroalkyl, a fluoroaryl, a bromoalkyl, a bromoaryl, a chloroalkyl, a chloroaryl, an alkylsulfone, an arylsulfone, an alkylamide, an arylamide, an alkylester, an arylester, a fluorine, a chlorine, and a bromine;
L is an integer from 0 to 4, preferably 0; and
t is an integer greater than 50, preferably greater than 100.

60. The reinforced thermoplastic composition of inventive concept 59, wherein the D-Glass fiber comprises:
50 to 76 wt. % of SiO₂,
8 to 30 wt. % of B₂O₃,
0 to 18 wt. % of Al₂O₃,
0 to 5 wt. % of TiO₂,
0 to 10 wt. % of MgO,
0 to 8 wt. % of CaO,
0 to 3 wt. % of ZnO,
0 to 1.1 wt. % of Li₂O,
0 to 2 wt. % of Na₂O,
0 to 2 wt. % of K₂O,
0 to 0.4 wt. % of Fe₂O, and
0 to 2 wt. % of F₂; and

wherein wt. % is relative to the total weight of the D-glass fiber.

61. The reinforced thermoplastic polymer composition of inventive concept 60, wherein the D-glass fiber has a dielectric constant at 10 GHz of 4 to 5.

62. The reinforced thermoplastic polymer composition of inventive concept 1, wherein the D-Glass fiber comprises:
50 to 76 wt. % of SiO₂,
8 to 30 wt. % of B₂O₃,
0 to 18 wt. % of Al₂O₃,
0 to 5 wt. % of TiO₂,
0 to 10 wt. % of MgO,
0 to 8 wt. % of CaO,
0 to 3 wt. % of ZnO,
0 to 1.1 wt. % of Li₂O,
0 to 2 wt. % of Na₂O,
0 to 2 wt. % of K₂O,
0 to 0.4 wt. % of Fe₂O, and
0 to 2 wt. % of F₂; and

wherein wt. % is relative to the total weight of the D-glass fiber.

63. The reinforced thermoplastic polymer composition of inventive concept 3, wherein the D-Glass fiber comprises:
50 to 76 wt. % of SiO₂,
8 to 30 wt. % of B₂O₃,
0 to 18 wt. % of Al₂O₃,
0 to 5 wt. % of TiO₂,
0 to 10 wt. % of MgO,
0 to 8 wt. % of CaO,
0 to 3 wt. % of ZnO,
0 to 1.1 wt. % of Li₂O,
0 to 2 wt. % of Na₂O,
0 to 2 wt. % of K₂O,
0 to 0.4 wt. % of Fe₂O, and
0 to 2 wt. % of F₂; and

wherein wt. % is relative to the total weight of the D-glass fiber.

64. The reinforced thermoplastic polymer composition of inventive concept 4, wherein the D-Glass fiber comprises:
50 to 76 wt. % of SiO₂,
8 to 30 wt. % of B₂O₃,
0 to 18 wt. % of Al₂O₃,
0 to 5 wt. % of TiO₂,
0 to 10 wt. % of MgO,
0 to 8 wt. % of CaO,
0 to 3 wt. % of ZnO,
0 to 1.1 wt. % of Li₂O,
0 to 2 wt. % of Na₂O,
0 to 2 wt. % of K₂O,
0 to 0.4 wt. % of Fe₂O, and
0 to 2 wt. % of F₂; and

wherein wt. % is relative to the total weight of the D-glass fiber.

65. The reinforced thermoplastic polymer composition of inventive concept 8, wherein the D-Glass fiber comprises:
50 to 76 wt. % of SiO₂,
8 to 30 wt. % of B₂O₃,
0 to 18 wt. % of Al₂O₃,
0 to 5 wt. % of TiO₂,
0 to 10 wt. % of MgO,
0 to 8 wt. % of CaO,
0 to 3 wt. % of ZnO,
0 to 1.1 wt. % of Li₂O,
0 to 2 wt. % of Na₂O,
0 to 2 wt. % of K₂O,
0 to 0.4 wt. % of Fe₂O, and
0 to 2 wt. % of F₂; and

wherein wt. % is relative to the total weight of the D-glass fiber.

66. The reinforced thermoplastic polymer composition of inventive concept 9, wherein the D-Glass fiber comprises:
50 to 76 wt. % of SiO₂,
8 to 30 wt. % of B₂O₃,
0 to 18 wt. % of Al₂O₃,
0 to 5 wt. % of TiO₂,
0 to 10 wt. % of MgO,
0 to 8 wt. % of CaO,
0 to 3 wt. % of ZnO,
0 to 1.1 wt. % of Li₂O,
0 to 2 wt. % of Na₂O,
0 to 2 wt. % of K₂O,
0 to 0.4 wt. % of Fe₂O, and
0 to 2 wt. % of F₂; and

wherein wt. % is relative to the total weight of the D-glass fiber.

67. The reinforced thermoplastic polymer composition of inventive concept 13, wherein the D-Glass fiber comprises:
50 to 76 wt. % of SiO₂,
8 to 30 wt. % of B₂O₃,
0 to 18 wt. % of Al₂O₃,
0 to 5 wt. % of TiO₂,
0 to 10 wt. % of MgO,
0 to 8 wt. % of CaO,
0 to 3 wt. % of ZnO,
0 to 1.1 wt. % of Li₂O,
0 to 2 wt. % of Na₂O,
0 to 2 wt. % of K₂O,
0 to 0.4 wt. % of Fe₂O, and
0 to 2 wt. % of F₂; and

wherein wt. % is relative to the total weight of the D-glass fiber.

68. The reinforced thermoplastic polymer composition of inventive concept 17, wherein the D-Glass fiber comprises:
50 to 76 wt. % of SiO₂,
8 to 30 wt. % of B₂O₃,
0 to 18 wt. % of Al₂O₃,
0 to 5 wt. % of TiO₂,
0 to 10 wt. % of MgO,
0 to 8 wt. % of CaO,
0 to 3 wt. % of ZnO,
0 to 1.1 wt. % of Li₂O,
0 to 2 wt. % of Na₂O,
0 to 2 wt. % of K₂O,
0 to 0.4 wt. % of Fe₂O, and
0 to 2 wt. % of F₂; and

wherein wt. % is relative to the total weight of the D-glass fiber.

69. The reinforced thermoplastic polymer composition of inventive concept 23, wherein the D-Glass fiber comprises:
50 to 76 wt. % of SiO₂,
8 to 30 wt. % of B₂O₃,
0 to 18 wt. % of Al₂O₃,
0 to 5 wt. % of TiO₂,
0 to 10 wt. % of MgO,
0 to 8 wt. % of CaO,
0 to 3 wt. % of ZnO,
0 to 1.1 wt. % of Li₂O,
0 to 2 wt. % of Na₂O,
0 to 2 wt. % of K₂O,
0 to 0.4 wt. % of Fe₂O, and
0 to 2 wt. % of F₂; and

wherein wt. % is relative to the total weight of the D-glass fiber.

70. The reinforced thermoplastic polymer composition of inventive concept 27 or 28, preferably 38, wherein the D-Glass fiber comprises:
50 to 76 wt. % of SiO₂,
8 to 30 wt. % of B₂O₃,
0 to 18 wt. % of Al₂O₃,
0 to 5 wt. % of TiO₂,
0 to 10 wt. % of MgO,
0 to 8 wt. % of CaO,
0 to 3 wt. % of ZnO,
0 to 1.1 wt. % of Li₂O,
0 to 2 wt. % of Na₂O,
0 to 2 wt. % of K₂O,
0 to 0.4 wt. % of Fe₂O, and
0 to 2 wt. % of F₂; and

wherein wt. % is relative to the total weight of the D-glass fiber.

71. The reinforced thermoplastic polymer composition of inventive concept 33, wherein the D-Glass fiber comprises:
50 to 76 wt. % of SiO₂,
8 to 30 wt. % of B₂O₃,
0 to 18 wt. % of Al₂O₃,
0 to 5 wt. % of TiO₂,
0 to 10 wt. % of MgO,
0 to 8 wt. % of CaO,
0 to 3 wt. % of ZnO,
0 to 1.1 wt. % of Li₂O,
0 to 2 wt. % of Na₂O,
0 to 2 wt. % of K₂O,
0 to 0.4 wt. % of Fe₂O, and
0 to 2 wt. % of F₂; and

wherein wt. % is relative to the total weight of the D-glass fiber.

72. The reinforced thermoplastic polymer composition of inventive concept 43, preferably 30, wherein the D-Glass fiber comprises:
50 to 76 wt. % of SiO₂,
8 to 30 wt. % of B₂O₃,
0 to 18 wt. % of Al₂O₃,
0 to 5 wt. % of TiO₂,
0 to 10 wt. % of MgO,
0 to 8 wt. % of CaO,
0 to 3 wt. % of ZnO,
0 to 1.1 wt. % of Li₂O,
0 to 2 wt. % of Na₂O,
0 to 2 wt. % of K₂O,
0 to 0.4 wt. % of Fe₂O, and
0 to 2 wt. % of F₂; and

wherein wt. % is relative to the total weight of the D-glass fiber.

73. A thermoplastic polymer composition comprising:
a polyamide polymer
20 wt. % to 85 wt. %, relative to the total weight of the reinforced thermoplastic polymer composition, of a flat D-glass fiber comprising an average aspect ratio of from 2:1 to 5:1

wherein
wherein the flat D-glass fiber has a dielectric constant at 1 MHz of 4 to 6, preferably from 4 to 5, most preferably from 4 to 4.5 and
the polyamide polymer comprises at least 50 mol % of a recurring unit (R_{PA}) represented by the following formula:

—[—M_{A}—M_{B}—]— (1)
where —M_{A}— is represented by a formula selected from the following group of formulae:

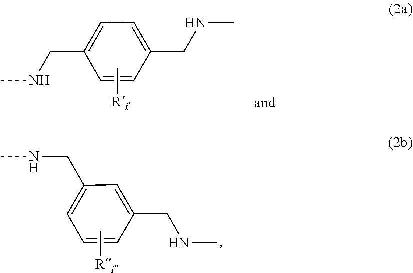

and where —M_{B}— is represented by the following formula :

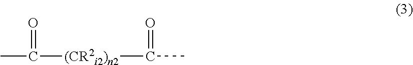

wherein
R² and R′ and R″ at each instance, is independently selected from the group consisting of a halogen, an alkyl, an alkenyl, an ether, a thioether, an ester, an amide, an imide, an alkali or alkaline earth metal sulfonate, an alkyl sulfonate, an alkali or alkaline earth metal phosphonate, an alkyl phosphonate, an amine, and an quaternary ammonium;
i₂, at each instance, is an independently selected integer from 0 to 2;
i′ and i″ are independently selected integers from 0 to 4; and
n₂ is an integer from 6 to 18,
preferably i′, i″ and i₂, at each instance, are zero and n₂ is 6 or 10.

74. The thermoplastic polymer composition of inventive concept 73, wherein M_{A} is represented by Formula (2a), preferably i′ and i₂, at each instance, are zero and n₂ is 6 or 10.

75. The thermoplastic polymer composition of inventive concept 74, wherein the polyamide polymer is selected from the group consisting of PXD6 and PXD10.

76. The reinforced thermoplastic composition of inventive concept 75, wherein the D-Glass fiber comprises:
50 to 76 wt. % of SiO₂,
8 to 30 wt. % of B₂O₃,
0 to 18 wt. % of Al₂O₃,
0 to 5 wt. % of TiO₂,
0 to 10 wt. % of MgO,
0 to 8 wt. % of CaO,
0 to 3 wt. % of ZnO,
0 to 1.1 wt. % of Li₂O,
0 to 2 wt. % of Na₂O,
0 to 2 wt. % of K₂O,
0 to 0.4 wt. % of Fe₂O, and
0 to 2 wt. % of F₂; and

wherein wt. % is relative to the total weight of the D-glass fiber.

77. The reinforced thermoplastic polymer composition of inventive concept 76, wherein the D-glass fiber has a dielectric constant at 10 GHz of 4 to 5.

78. The thermoplastic polymer composition of inventive concept 73, wherein M_{A} is represented by Formula (2b), preferably i″ and i₂, at each instance, are zero and n₂ is 6 or 10.

79. The thermoplastic polymer composition of inventive concept 78, wherein the polyamide polymer is selected from the group consisting of MXD6 and MXD10.

80. The reinforced thermoplastic composition of inventive concept 79, wherein the D-Glass fiber comprises
50 to 76 wt. % of SiO₂
8 to 30 wt. % of B₂O₃
0 to 18 wt. % of Al₂O₃
0 to 5 wt. % of TiO₂
0 to 10 wt. % of MgO
0 to 8 wt. % of CaO
0 to 3 wt. % of ZnO
0 to 1.1 wt. % of Li₂O
0 to 2 wt. % of Na₂O
0 to 2 wt. % of K₂O
0 to 0.4 wt. % of Fe₂O
0 to 2 wt. % of F₂

wherein wt. % is relative to the total weight of the D-glass fiber.

81. The reinforced thermoplastic polymer composition of inventive concept 80, wherein the D-glass fiber has a dielectric constant at 10 GHz of 4 to 5.

82. The reinforced thermoplastic polymer composition of any one of inventive concepts 1 to 81 (each combination of the present inventive concept 82 with each one of inventive concepts 1 to 81 individually and specifically contemplated) wherein
the flat D-glass fiber has a tensile strength from 1000 megapascals (“MPa”) to 3000 MPa, preferably from 2000 MPa to 2500 MPa and
a tensile modulus of from 20 gigapascals (“GPa”) to 90 GPa.

83. The reinforced thermoplastic polymer composition of any one of inventive concepts 2 to 20 (each combination of the present inventive concept 83 with each one of inventive concepts 2 to 20 individually and specifically contemplated), wherein
the polyamide polymer has an inherent viscosity from 0.5 to 2.0 dL/g, measured according to ASTM D5336, and
the polyamide polymer has a melting point from 180° C. to 340° C., measured using differential scanning calorimetry (“DSC”) according to ISO-11357-3.

84. The reinforced thermoplastic polymer composition of any one of inventive concepts 21 to 32 (each combination of the present inventive concept 84 with each one of inventive concepts 21 to 32 individually and specifically contemplated), wherein
the polyester polymer has an inherent viscosity of from 0.4 deciliters per gram (“dL/g”) to 2.0 dL/g, as measured in a 60:40 phenol/tetrachloroethane mixture at 30° C. according to ASTM D5225 and
the polyester polymer has a melting point of at least 250° C. and at most 350° C., as measured using differential scanning calorimetry (“DSC”) according to ISO-11357-3.

85. The reinforced thermoplastic polymer composition of claim 21, wherein the polyester polymer comprises at least 50 mol % of recurring units formed from the polycondensation of the following three monomers : dimethyl terephthalate, 2,2,4,4,-tetramethyl-1,3,-cyclobutanediol and 1,4-clyclohexanedimethanol.

86. The reinforced thermoplastic composition of inventive concept 85, wherein the D-Glass fiber comprises:
50 to 76 wt. % of SiO₂,
8 to 30 wt. % of B₂O₃,
0 to 18 wt. % of Al₂O₃,
0 to 5 wt. % of TiO₂,
0 to 10 wt. % of MgO,
0 to 8 wt. % of CaO,
0 to 3 wt. % of ZnO,
0 to 1.1 wt. % of Li₂O,
0 to 2 wt. % of Na₂O,
0 to 2 wt. % of K₂O,
0 to 0.4 wt. % of Fe₂O, and
0 to 2 wt. % of F₂; and

wherein wt. % is relative to the total weight of the D-glass fiber.

87. The reinforced thermoplastic polymer composition of inventive concept 86, wherein the D-glass fiber has a dielectric constant at 10 GHz of 4 to 5.

Should the disclosure of any patents, patent applications, and publications which are incorporated herein by reference conflict with the description of the present application to the extent that it may render a term unclear, the present description shall take precedence.

1. A reinforced thermoplastic polymer composition comprising:
a thermoplastic polymer selected from the group consisting of polyester polymer, a poly(aryl ether ketone) (“PAEK”) polymer and a polyphenylene sulfide (“PPS”) polymer; and
20 wt. % to 85 wt. %, relative to the total weight of the thermoplastic polymer composition, of a flat, low dielectric glass (“D-glass”) fiber comprising an aspect ratio of from 2:1 to 5:1,
wherein
the flat D-glass fiber has a dielectric constant at 1 MHz of 4 to 6, preferably from 4 to 5, most preferably from 4 to 4.5.

2. (canceled)

3. (canceled)

4. (canceled)

5. (canceled)

6. (canceled)

7. The thermoplastic polymer composition of claim 1, wherein the polyester polymer comprises at least 50 mol % of a recurring unit (R_{PE}) represented by the following formula: 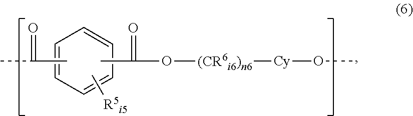
wherein
R⁵ and R⁶, at each location, is independently selected from the group consisting of a halogen, an alkyl, an alkenyl, an alkynyl, an aryl, an ether, a thioether, a carboxylic acid, an ester, an amide, an imide, an alkali or alkaline earth metal sulfonate, an alkyl sulfonate, an alkali or alkaline earth metal phosphonate, an alkyl phosphonate, an amine and a quaternary ammonium;
Cy is a bond or a substituted cycloaliphatic group containing a monovalent alkyl group and monovalent cycloaliphatic group;
i₅ is an integer from 0 to 4;
i₆, at each instance, is an independently selected integer from 0 to 2; and
n₆ is an integer from 1 to 12.

8. The thermoplastic polymer composition of claim 7, wherein recurring unit (R_{PE}) is represented by the following formula:

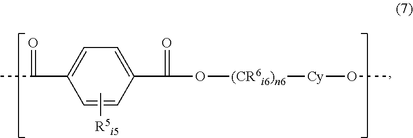

9. The thermoplastic polymer composition of claim 8, wherein the polyester polymers is selected from the group consisting of a polytrimethylene terephthalate polymer, a polyethylene terephthalate polymer, and a polybutylene terephthalate polymer.

10. The thermoplastic polymer composition of claim 8, wherein Cy is represented by the following formula:

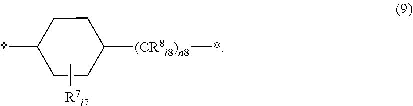

11. (canceled)

12. (canceled)

13. (canceled)

14. The reinforced thermoplastic composition of claim 1, wherein the D-Glass fiber comprises:
50 to 76 wt. % of SiO₂,
8 to 30 wt. % of B₂O₃,
0 to 18 wt. % of Al₂O₃,
0 to 5 wt. % of TiO₂,
0 to 10 wt. % of MgO,
0 to 8 wt. % of CaO,
0 to 3 wt. % of ZnO,
0 to 1.1 wt. % of Li₂O,
0 to 2 wt. % of Na₂O,
0 to 2 wt. % of K₂O,
0 to 0.4 wt. % of Fe₂O, and
0 to 2 wt. % of F₂; and
wherein wt. % is relative to the total weight of the D-glass fiber.

15. The reinforced thermoplastic polymer composition of claim 1, wherein the D-glass fiber has a dielectric constant at 10 GHz of 4 to 5.

16. The reinforced thermoplastic polymer composition of claim 1, wherein the thermoplastic polymer is a PAEK polymer comprising at least 50 mol % of a recurring unit (R_{PAEK}) represented by a formula selected from the following of group of formulae: 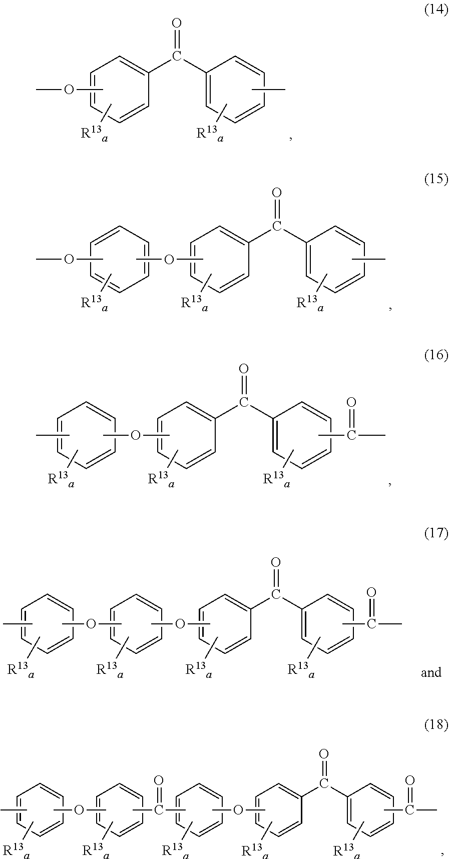
wherein
R¹³, at each instance, is independently selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and
a, at each instance, is an independently selected integer from 0 to 4.

17. The reinforced thermoplastic polymer composition of claim 16, wherein recurring unit (R_{PAEK}) is represented by the formula:

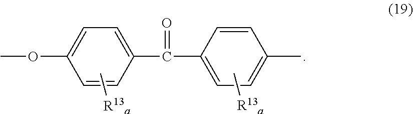

18. The reinforced thermoplastic polymer composition of claim 16, wherein recurring unit (R_{PAEK}) is represented by the formula:

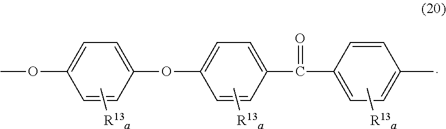

19. The reinforced thermoplastic polymer composition of claim 16, wherein the thermoplastic polymer further comprises recurring unit (R*_{PAEK}), and wherein recurring unit (R_{PAEK}) and recurring unit (R*_{PAEK}) are respectively represented by the following formulae:

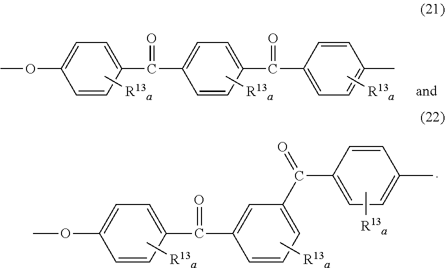

20. The reinforced thermoplastic polymer composition of claim 16, wherein recurring unit (R_{PAEK}) is represented by the following formula:

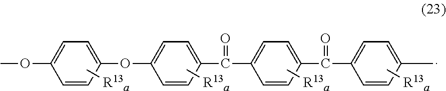

21. The reinforced thermoplastic polymer composition of claim 16, wherein recurring unit (R_{PAEK}) is represented by the following formula:

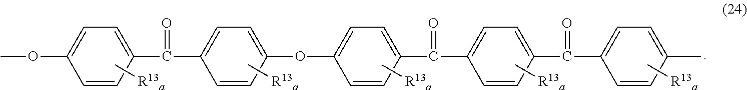

22. The reinforced thermoplastic polymer composition of claim 1, wherein the polymer is a PPS polymer comprising at least 50 mol % of a recurring unit (R_{PPS}) represented by the following formula: 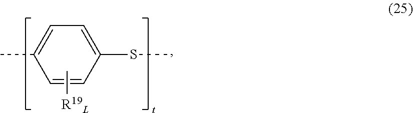
wherein
R¹⁹, at each location, is independently selected from the group consisting of an alkyl, an aryl, an alkoxy, an aryloxy, an alkylketone, an arylketone, a fluoroalkyl, a fluoroaryl, a bromoalkyl, a bromoaryl, a chloroalkyl, a chloroaryl, an alkylsulfone, an arylsulfone, an alkylamide, an arylamide, an alkylester, an arylester, a fluorine, a chlorine, and a bromine;
L is an integer from 0 to 4; and
t is an integer greater than 50.
